(19) United States
(12) Patent Application Publication
(10) Pub. No.: US 2019/0352479 A1
(43) Pub. Date: Nov. 21, 2019

(54) SILICONE ELEMENT COATED WITH A SCRATCH-RESISTANT AND ANTI-FRICTION COATING AND PROCESS FOR MANUFACTURING SAME

(71) Applicant: SAINT-GOBAIN PERFORMANCE PLASTICS FRANCE, Charny Orée de Puisaye (FR)

(72) Inventors: Hadrien HEUCLIN, Paris (FR); Harayer CHILINGUIRIAN, Bagnolet (FR)

(21) Appl. No.: 16/526,566

(22) Filed: Jul. 30, 2019

Related U.S. Application Data
(63) Continuation-in-part of application No. PCT/EP2018/052527, filed on Feb. 1, 2018.

(30) Foreign Application Priority Data
Feb. 1, 2017 (FR) 1750822

(51) Int. Cl. C08J 7/04; B05D 7/04; B05D 3/14; C09D 175/06

(52) U.S. Cl. CPC C08J 7/047; B05D 7/04; C08J 2475/06; C09D 175/06; C08J 2383/04; B05D 3/144

(57) ABSTRACT

A process for forming an elastic coating on a silicone support, includes:
(a) treating at least one zone of the surface of a silicone part to increase the surface energy of the treated zone to a value greater than 30 mJ/m²,
(b) depositing onto at least part of the treated zone a coating composition including:
   (i) a latex of a film-forming organic polymer bearing functions containing active hydrogen,
   (ii) an aqueous dispersion of a very high molecular weight polyorganosiloxane, and
   (iii) a crosslinking agent chosen from polyisocyanates,
(c) heating or irradiating the layer of coating composition to react the crosslinking agent (iii) with the functions containing active hydrogen of the film-forming organic polymer (i) to form an elastic coating,
   components (i), (ii) and (iii) and the respective proportions thereof being chosen such that the support equipped with the coating can be elongated without the appearance of cracks in the coating.

### CROSS-REFERENCE TO RELATED APPLICATIONS

The present application is a continuation-in-part of and claims priority under 35 U.S.C. § 120 to International Application No. PCT/EP2018/052527, entitled “SILICONE ELEMENT COATED WITH A SCRATCH-RESISTANT AND ANTI-FRICTION COATING AND PROCESS FOR MANUFACTURING SAME”, by Hadrien HEUCLIN et al., filed Feb. 1, 2018, which claims priority to French Patent Application No. 1750822, entitled “SILICONE ELEMENT COATED WITH A SCRATCH-RESISTANT AND ANTI-FRICTION COATING AND PROCESS FOR MANUFACTURING SAME”, by Hadrien HEUCLIN et al., filed Feb. 1, 2017, both of which applications are incorporated by reference herein in their entireties.

### FIELD OF THE DISCLOSURE

The present invention relates to a silicone part bearing a scratch-resistant coating with a low coefficient of friction, and to a process for preparing such a silicone part.

### BACKGROUND

Solid silicones are materials that are distinguished by their longevity, their flexibility, their relatively limited cost, their great chemical inertness and their good fire resistance and resistance to high and low temperatures.

Their low elastic modulus and their high coefficient of friction are, unfortunately, reflected by low scratch resistance and abrasion resistance and by a slightly tacky feel.

One approach for overcoming these drawbacks was to cover the surfaces of silicone parts with a thin film of parylene. Parylene films conventionally have a thickness of between 2 and 20 μm and spectacularly reduce the coefficient of friction of covered surfaces. They are relatively hard, sparingly elastic films, which withstand temperatures ranging up to 125° C.

As a result of their vapour-phase of deposition process, they are not chemically bonded to the silicone substrate, and when this substrate undergoes deformations, the parylene films crack and become detached, which is unsatisfactory aesthetically and also in terms of efficiency.

The aim of the present invention is to propose a surface treatment for silicone parts which does not suffer from the drawbacks of a treatment by deposition of a parylene film (cracking and detachment of the film), while at the same time offering the same advantages (reduction of the coefficient of friction and the sensitivity to scratches and to abrasion).

### SUMMARY

In an embodiment, a process for forming an elastic coating on a silicone support is provided. The process includes the following:
(a) treating at least one zone of the surface of a silicone part so as to increase the surface energy of the treated zone to a value greater than 30 mJ/m², such as greater than 35 mJ/m²,
(b) depositing onto at least part of the treated zone a coating composition including:
   (i) a latex of a film-forming organic polymer bearing functions containing active hydrogen,
   (ii) an aqueous dispersion of a very high molecular weight polyorganosiloxane, and
   (iii) a crosslinking agent chosen from polyisocyanates,
(c) heating or irradiating the layer of coating composition so as to react the crosslinking agent (iii) with the functions containing active hydrogen of the film-forming organic polymer (i) and thus to form an elastic coating,
   components (i), (ii) and (iii) and the respective proportions thereof being chosen such that the support equipped with the coating can be elongated from at least 80% to at least 400% without the appearance of cracks in the coating.

### DETAILED DESCRIPTION

The following description is provided to assist in understanding the teachings disclosed herein. The following discussion focuses on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having” or any other variation thereof, are open-ended terms and should be interpreted to mean “including, but not limited to . . . . ” These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts.

The idea on which the present invention is based is to incorporate a lubricant component chosen from very high molecular weight polyorganosiloxanes (such as ultra-high molecular weight silicones) into a polymer matrix obtained by crosslinking a two-pack reactive system including a film-forming organic polymer and a crosslinking agent. The crosslinked polymer coating thus formed has an elasticity close to that of the silicone substrate and therefore does not crack in the event of mechanical stress. Moreover, when, before the application of the coating composition, a step of activation of the surface of the silicone substrate is performed, which makes available the silanol groups thereof, the coating can be attached via covalent bonds to the underlying substrate. It then does not separate from the substrate by peeling, and is firmly attached to the substrate.

Consequently, one subject of the present invention is a process for forming an elastic coating on a silicone support, including the following three successive steps:
(a) treating at least one zone of the surface of a silicone part so as to increase the surface energy of the treated zone to a value greater than 30 mJ/m², such as greater than 35 mJ/m²,
(b) depositing onto at least part of the treated zone a coating composition including:
   (i) a latex of a film-forming organic polymer bearing functions containing active hydrogen,
   (ii) an aqueous dispersion of a very high molecular weight polyorganosiloxane, such as of a very high molecular weight polydimethylsiloxane (PDMS), and
   (iii) a crosslinking agent chosen from polyisocyanates, and
(c) heating or irradiating the layer of coating composition so as to react the crosslinking agent (iii) with the functions containing active hydrogen of the film-forming organic polymer (i) and thus to form an elastic coating,
   components (i), (ii) and (iii) and the respective proportions thereof being chosen such that the support equipped with the coating can be elongated from at least 80% to at least 400% without the appearance of cracks in the coating.

In order for the coating not to crack when the silicone part is stretched, it must have a sufficient elasticity. In an embodiment, components (i), (ii) and (iii) and the respective proportions thereof are thus chosen so that the elastic modulus, measured by nanoindentation at 45 Hz, of the final elastic coating is between 1 MPa and 10 GPa, and in a particular embodiment, between 50 MPa and 2 GPa.

In order for the lubricant elastic coating of the present invention to adhere optimally to the silicone part, it is desirable to prepare the surface of said part with a surface treatment leading to an increase in its surface energy. The silicone (for example, the polyorganosiloxane) generally has, before treatment, a surface energy of the order of 20 mJ/m². However, such a surface is not satisfactorily wetted with an aqueous coating composition and does not include a sufficient number of reactive functions.

In the present invention, the zone of the surface of the silicone part that is liable to come into contact with the coating composition is thus subjected to a surface treatment for increasing the surface energy to a value at least equal to 30 mJ/m². All the surface energy values in the present invention are understood as having been determined via the sessile drop method using the Owens-Wendt theory (D. Owens; R. Wendt, Estimation of the Surface Free Energy of Polymers in J. Appl. Polym. Sci., 13 (1969), pages 1741-1747).

The surface treatment is advantageously a treatment by flame, by plasma containing oxygen (O₂), by plasma torch, by corona discharge, by infrared irradiation, by UV-ozone, or alternatively a chemical treatment, for example with a strong acid, a strong base or an oxidizing agent.

It is desirable to perform this hydrophilizing treatment shortly before the treated surface comes into contact with the non-silicone structural adhesive. The hydrophilic nature of the treated zone is, in point of fact, only transient and disappears quite quickly. This phenomenon, which is known as “hydrophobic recovery”, may take place within a few minutes only and is generally attributed to the condensation of the silanol groups, the reorientation of polar groups and the migration of low molecular weight components from the interior of the part to the surface.

In the process of the present invention, the surface treatment of step (a) is advantageously performed less than 5 minutes, such as less than 3 minutes, or even less than 1 minute before placing the treated zone in contact with the coating composition containing ingredients (i), (ii) and (iii).

It is also important to note that the lubricant elastic coating is formed directly on the treated surface of the silicone part, i.e. after step (a), the coating composition is applied directly onto the treated surface, without prior deposition of a priming layer.

The coating composition used in the present invention is an aqueous composition including the following ingredients:
film-forming organic polymer bearing functions containing active hydrogen, for example hydroxyl (—OH), carboxyl (—COOH), amine (—NRH, NH₂) or mercapto (—SH) functions;
a crosslinking agent capable of reacting both with the functions containing active hydrogen of the film-forming organic polymer and with the silanol functions of the surface of the treated silicone,
a high molecular weight silicone lubricant.

The two polymeric ingredients, i.e. the film-forming organic polymer and the high molecular weight silicone lubricant, are each in the form of aqueous dispersions (latex), which ensures good mixing of these two components and low viscosity of the coating composition at the time of application.

The film-forming organic polymer used in the present invention bears reactive functions containing active hydrogen, i.e. —OH, —COOH, NRH, NH₂ or SH functions. Examples of such film-forming polymers that may be mentioned include:
epoxy resins bearing hydroxyl functions,
hydroxylated polyetherurethanes,
hydroxylated polyesterurethanes, obtained by reacting a hydroxylated polyester with a polyisocyanate and a hydroxy acid; these polyesters contain both hydroxyl groups and acid groups, such as carboxylic acid groups, which make these polymers water-dispersible, even in the absence of surfactants. Such anionic polyesterurethanes are described, for example, in EP 0 746 579, U.S. Pat. Nos. 3,539,483, 5,354,807, 5,569,707, 5,710,209, 7,557,156 and 7,902,302.

In a particular embodiment, the latex of film-forming organic polymer is an anionic polyesterurethane. In a more particular embodiment, the anionic polyesterurethane is carboxylated.

Latices of film-forming organic polymers bearing functions containing active hydrogen are sold, for example, by the company Covestro under the name BayHydrol®, by the company Dow Chemical under the name Syntegra®, by the company Lubrizol under the name SanCure® and by the company Ashland under the name Derakane®.

The second ingredient of the coating composition of the present invention is a very high molecular weight polyorganosiloxane (such as ultra-high molecular weight silicone or UHMW silicone), such as a very high molecular weight polydimethylsiloxane (UHMW PDMS).

In the present invention, the term “very high molecular weight polyorganosiloxane” means a polyorganosiloxane with a weight-average molecular weight of greater than 200 000 Daltons (determination by size exclusion chromatography in THF (tetrahydrofuran)).

The very high molecular weight polyorganosiloxane used as lubricant additive in the present invention includes hydroxyl functions for anchoring this ingredient in the three-dimensional network of the coating and for preventing its demixing. In a particular embodiment, the polyisocyanate (crosslinking agent) reacts with the silanol functions of the very high molecular weight polyorganosiloxane, with the silanol functions of the treated surface of the silicone part and with the groups containing active hydrogen of the film-forming organic polymer so as to bond these components to each other via covalent bonds.

An example of a very high molecular weight polydimethylsiloxane that may be mentioned is Dow Corning® 52 Additive, sold by the company Dow Corning.

The third ingredient of the present invention may be chosen from a very large number of known and commercially available polyisocyanates.

The polyisocyanates used in the present invention are typically diisocyanates such as methylenediphenyl diisocyanate (MDI), isophorone diisocyanate (IPDI) and hexamethylene diisocyanate.

The coating composition typically includes from 50% to 90% by weight of latex of film-forming organic polymer bearing functions containing active hydrogen (component (i)), from 0.5% to 5% by weight of high molecular weight polyorganosiloxane (component (ii)), and from 10% to 40% by weight of polyisocyanate (component (iii)), these percentages being expressed as solids relative to the sum of the three components (i), (ii) and (iii).

Its solids content is typically between 35% and 55%.

The coating composition used in the present invention may also contain from 0.1% to 10% by weight, such as from 0.2% to 5% by weight and in particular from 0.3% to 3% by weight, relative to the sum of the components (i), (ii) and (iii), of a filler, such as a mineral filler.

The coating composition is deposited onto the treated surface of the silicone part via known techniques such as treatment by flame, by plasma containing oxygen (O₂) or nitrogen (N₂), by plasma torch, by corona discharge, by infrared irradiation, by UV-ozone, or alternatively a chemical treatment, for example with a strong acid, a strong base or an oxidizing agent.

Crosslinking of the deposited coating takes place by heating the coating. The coating is typically heated to a temperature of between 20 and 120° C. for a time of between 10 minutes and 24 hours.

Its thickness after crosslinking is typically between 5 μm and 1000 μm, such as between 10 μm and 100 μm.

A subject of the present invention is also a part formed from a silicone support and an elastic coating, obtained via a process as described above.

The determined coefficient of friction of the elastic coating is typically between 0.1 and 1.5.

The indentation modulus of the polymer film was measured by nanoindentation. The contact stiffness was measured throughout the indentation experiment using the “continuous stiffness measurement” module at a frequency of 45 Hz and an amplitude of 2 nm. The contact stiffness was translated into a modulus using the Oliver-Pharr model and taking into account the effect of the substrate (Hay, J., & Crawford, B. (2011). Measuring substrate-independent modulus of thin films. Journal of Materials Research, 26(06), 727-738.).

The tensile testing experiment for the appearance of cracks was performed on a tensile testing machine with a type 2 specimen according to standard ISO 37 at 10 mm/min with an initial distance between the jaws equal to 45 mm.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. A process for forming an elastic coating on a silicone support, includes the following:
(a) treating at least one zone of the surface of a silicone part so as to increase the surface energy of the treated zone to a value greater than 30 mJ/m², such as greater than 35 mJ/m²,
(b) depositing onto at least part of the treated zone a coating composition including:
   (i) a latex of a film-forming organic polymer bearing functions containing active hydrogen,
   (ii) an aqueous dispersion of a very high molecular weight polyorganosiloxane, and
   (iii) a crosslinking agent chosen from polyisocyanates,
(c) heating or irradiating the layer of coating composition so as to react the crosslinking agent (iii) with the functions containing active hydrogen of the film-forming organic polymer (i) and thus to form an elastic coating,
components (i), (ii) and (iii) and the respective proportions thereof being chosen such that the support equipped with the coating can be elongated from at least 80% to at least 400% without the appearance of cracks in the coating.

Embodiment 2. The process according to embodiment 1, characterized in that components (i), (ii) and (iii) and the respective proportions thereof are chosen so that the elastic modulus, measured by nanoindentation at 45 Hz, of the final elastic coating is between 1 MPa and 10 GPa, such as between 50 MPa and 2 GPa.

Embodiment 3. The process according to embodiments 1 or 2, characterized in that the surface treatment of the silicone part is a treatment by flame, by plasma containing oxygen (O₂) or nitrogen (N₂), by plasma torch, by corona discharge, by infrared irradiation, by UV-ozone, or alternatively a chemical treatment, for example with a strong acid, a strong base or an oxidizing agent.

Embodiment 4. The process according to any one of the preceding embodiments, characterized in that the coating composition is applied directly onto the treated surface, without prior deposition of a priming layer.

Embodiment 5. The process according to any one of the preceding embodiments, characterized in that the latex of film-forming organic polymer bearing functions containing active hydrogen is chosen from polyesterurethanes bearing hydroxyl functions, polyetherurethanes bearing hydroxyl functions and epoxide resins bearing hydroxyl functions.

Embodiment 6. The process according to embodiment 5, characterized in that the latex of organic polymer bearing functions containing active hydrogen is an anionic polyesterurethane, which is in a particular embodiment, carboxylated.

Embodiment 7. The process according to any one of the preceding embodiments, characterized in that the coating composition includes from 50% to 90% by weight of latex of film-forming organic polymer bearing functions containing active hydrogen (component (i)), from 0.5% to 5% by weight of high molecular weight polyorganosiloxane (component (ii)), and from 10% to 40% by weight of polyisocyanate (component (iii)), these percentages being expressed as solids relative to the sum of the three components (i), (ii) and (iii).

Embodiment 8. The process according to any one of the preceding embodiments, characterized in that the high molecular weight polyorganosiloxane bears functions containing active hydrogen, such as silanol functions.

Embodiment 9. The process according to any one of the preceding embodiments, characterized in that the coating composition also contains from 0.1% to 10% by weight, such as from 0.2% to 5% by weight, or even from 0.3% to 3% by weight, relative to the sum of components (i), (ii) and (iii), of a filler, such as a mineral filler.

Embodiment 10. The process according to any one of the preceding embodiments, characterized in that the thickness of the elastic coating obtained at the end of step (c) is between 5 and 1000 μm, such as between 10 and 100 μm.

Embodiment 11. A part formed from a silicone support and an elastic coating, obtained via a process according to any one of the preceding embodiments.

Embodiment 12. The part according to embodiment 11, characterized in that the coefficient of friction of the elastic coating is between 0.1 and 1.5.

Embodiment 13. The part according to embodiments 11 or 12, characterized in that the scratch resistance of the elastic coating, measured according to standard ISO 1518, is greater than 10 N.

The concepts described herein will be further described in the following examples, which do not limit the scope of the disclosure described in the claims. The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

### Example 1 (according to the invention):

A silicone part is made by moulding, crosslinking and then annealing a silicone formulation. The surface that is to receive the coating is treated with a corona discharge (50 kHz, 21 kV, 15 seconds). A coating composition composed of 3.7 g of Bayhydrol UH 340/1 (dispersion of anionic aliphatic polyurethane), 3.17 g of Bayhydrol U XP 2698 (dispersion of polyester polyurethane bearing hydroxyl functions), 1.4 g of Bayhydur XP 2547 (polyisocyanate), 1.68 g of water and 150 mg of Dow Corning Additive 52 (high molecular weight PDMS) is then applied to the treated surface so as to obtain a film 20 μm thick. After drying for 2 hours at 60° C. and then leaving to stand for at least 2 hours at room temperature, the silicone part thus coated has a coefficient of friction of less than 1.5, a scratch resistance according to standard ISO 1518 of greater than 15 N and an elongation without cracking of at least 150%.

### Example 2 (comparative):

A silicone part is produced by moulding, crosslinking and then annealing a silicone formulation. The surface that is to receive the coating is treated with a corona discharge (50 kHz, 21 kV, 15 seconds). A coating composition composed of 3.7 g of Bayhydrol UH 340/1 (dispersion of anionic aliphatic polyurethane), 3.17 g of Bayhydrol U XP 2698 (dispersion of polyester polyurethane bearing hydroxyl functions), 1.4 g of Bayhydur XP 2547 (polyisocyanate) and 1.68 g of water is then applied to the treated surface. After drying for 2 hours at 60° C. and then leaving to stand for at least 2 hours at room temperature, the silicone part thus coated has a coefficient of friction of less than 1.5, a scratch resistance according to standard ISO 1518 of less than 10 N and an elongation without cracking of at least 150%.

### Example 3 (comparative):

A silicone part is produced by moulding, crosslinking and then annealing a silicone formulation. A coating composition composed of 3.7 g of Bayhydrol UH 340/1 (dispersion of anionic aliphatic polyurethane), 3.17 g of Bayhydrol U XP 2698 (dispersion of polyester polyurethane bearing hydroxyl functions), 1.4 g of Bayhydur XP 2547 (polyisocyanate), 1.68 g of water and 150 mg of Dow Corning Additive 52 (high molecular weight PDMS) is then applied to the surface. No homogeneous film is obtained on the silicone support.

### Example 4 (comparative):

A silicone part is produced by moulding, crosslinking and then annealing a silicone formulation. The surface that is to receive the coating is treated with a corona discharge (50 kHz, 21 kV, 15 seconds). A coating of one-pack polyurethane type (polyurethane resin comprising hydroxyl and isocyanate groups grafted onto the polymer chain) is deposited on the treated face. After drying for 24 hours, the film obtained shows no adhesion to the support.

### Example 5 (comparative):

A silicone part is produced by moulding, crosslinking and then annealing a silicone formulation. The surface that is to receive the coating is treated with a corona discharge (50 kHz, 21 kV, 15 seconds). A coating composition composed of 2.25 g of Bayhydrol A2546 (dispersion of anionic polyacrylate), 2.25 g of Bayhydrol A2542 (dispersion of polyacrylic bearing hydroxyl functions), 2.1 g of Bayhydrol UH 340/1 (dispersion of anionic aliphatic polyurethane), 1.66 g of Bayhydur XP 2547 (polyisocyanate) and 1.66 g of water is then applied to the treated surface. After drying for 24 hours, the silicone part obtained has a coefficient of friction of less than 1.5 and a scratch resistance according to standard ISO 1518 of less than 5 N. The elongation without the appearance of cracks is less than 80%.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A process for forming an elastic coating on a silicone support, comprises the following:
(a) treating at least one zone of the surface of a silicone part so as to increase the surface energy of the treated zone to a value greater than 30 mJ/m², such as greater than 35 mJ/m²,
(b) depositing onto at least part of the treated zone a coating composition comprising:
(i) a latex of a film-forming organic polymer bearing functions containing active hydrogen,
(ii) an aqueous dispersion of a very high molecular weight polyorganosiloxane, and
(iii) a crosslinking agent chosen from polyisocyanates,
(c) heating or irradiating the layer of coating composition so as to react the crosslinking agent (iii) with the functions containing active hydrogen of the film-forming organic polymer (i) and thus to form an elastic coating,
components (i), (ii) and (iii) and the respective proportions thereof being chosen such that the support equipped with the coating can be elongated from at least 80% to at least 400% without the appearance of cracks in the coating.

2. The process according to claim 1, characterized in that components (i), (ii) and (iii) and the respective proportions thereof are chosen so that the elastic modulus, measured by nanoindentation at 45 Hz, of the final elastic coating is between 1 MPa and 10 GPa, such as between 50 MPa and 2 GPa.

3. The process according to claim 1, characterized in that the surface treatment of the silicone part is a treatment by flame, by plasma containing oxygen (O₂) or nitrogen (N₂), by plasma torch, by corona discharge, by infrared irradiation, by UV-ozone, or alternatively a chemical treatment, for example with a strong acid, a strong base or an oxidizing agent.

4. The process according to claim 1, characterized in that the coating composition is applied directly onto the treated surface, without prior deposition of a priming layer.

5. The process according to claim 1, characterized in that the latex of film-forming organic polymer bearing functions containing active hydrogen is chosen from polyesterurethanes bearing hydroxyl functions, polyetherurethanes bearing hydroxyl functions and epoxide resins bearing hydroxyl functions.

6. The process according to claim 5, characterized in that the latex of organic polymer bearing functions containing active hydrogen is an anionic polyesterurethane.

7. The process according to claim 6, wherein the anionic polyesterurethane is carboxylated.

8. The process according to claim 1, characterized in that the coating composition comprises from 50% to 90% by weight of latex of film-forming organic polymer bearing functions containing active hydrogen (component (i)), from 0.5% to 5% by weight of high molecular weight polyorganosiloxane (component (ii)), and from 10% to 40% by weight of polyisocyanate (component (iii)), these percentages being expressed as solids relative to the sum of the three components (i), (ii) and (iii).

9. The process according to claim 1, characterized in that the high molecular weight polyorganosiloxane bears functions containing active hydrogen.

10. The process according to claim 9, wherein the polyoranosiloxane bears silanol functions.

11. The process according to claim 1, characterized in that the coating composition also contains from 0.1% to 10% by weight, such as from 0.2% to 5% by weight, or even from 0.3% to 3% by weight, relative to the sum of components (i), (ii) and (iii), of a filler, such as a mineral filler.

12. The process according to claim 1, characterized in that the thickness of the elastic coating obtained at the end of step (c) is between 5 and 1000 μm, such as between 10 and 100 μm.

13. A part formed from a silicone support and an elastic coating, obtained via a process according to claim 1.

14. The part according to claim 13, characterized in that the coefficient of friction of the elastic coating is between 0.1 and 1.5.

15. The part according to claim 13, characterized in that the scratch resistance of the elastic coating, measured according to standard ISO 1518, is greater than 10 N.
